(19) United States
(12) Patent Application Publication
(10) Pub. No.: US 2025/0164838 A1
(43) Pub. Date: May 22, 2025

(54) PHOTOALIGNMENT LAYER FOR LIQUID CRYSTAL DEVICES

(71) Applicant: The Hong Kong University of Science and Technology, Hong Kong (CN)

(72) Inventors: Valerii Volodymyrovych VASHCHENKO, Hong Kong (CN); Oleksandr Mykolaiovych SEMENENKO, Hong Kong (CN); Xinyi YU, Hong Kong (CN); Abhishek Kumar SRIVASTAVA, Hong Kong (CN)

(21) Appl. No.: 18/948,692

(22) Filed: Nov. 15, 2024

Related U.S. Application Data
(60) Provisional application No. 63/599,572, filed on Nov. 16, 2023.

(51) Int. Cl. G02F 1/1337

(52) U.S. Cl. CPC G02F 1/133711; G02F 1/133746; G02F 1/133749; G02F 1/133788

(57) ABSTRACT

A photoalignment layer useful in the fabrication of liquid crystals including at least one precursor compound, wherein the at least one precursor compound includes a phosphonic acid anchor moiety and a dimerizable or polymerizable moiety, a method of preparing a photoalignment layer including a dimerized or polymerized compound, and products thereof.

### CROSS-REFERENCE TO RELATED APPLICATIONS

The present application claims priority from U.S. Provisional Patent Application No. 63/599,572, filed on Nov. 16, 2023, which is hereby incorporated by reference in its entirety.

### STATEMENT REGARDING PRIOR DISCLOSURES BY THE INVENTORS OR JOINT INVENTORS UNDER 37 CFR 1.77(b)(6)

Part of the present invention was disclosed in a paper published in Xinyi Yu, et al. P-92: Photo-sensitive Vertical Alignment Material with Room Temperature Dip-coating Technique, Society for Information Display, Digest of Technical Papers, Volume 55, Issue 1, 1743-1746, 2024. This paper is a grace period inventor-originated disclosure disclosed within one year before the filing date of this application and falls within the exceptions defined under 35 USC § 102(b)(1). This paper is hereby incorporated by reference in its entirety.

### TECHNICAL FIELD

The present disclosure relates to precursor compounds useful for preparing photoalignment layers and methods of use and products thereof.

### BACKGROUND

The alignment of liquid crystals can be performed by various methods known in the art. In one example, a rubbing method can be used wherein a polymer film, such as a polyimide, is rubbed in a predetermined direction by fibers or a cloth material. However, this method suffers from several disadvantages, such as for example, practical difficulties, including particles left by fibers or cloth material on the substrate surface, which can lead to defects as well as static charge buildup, which can attract particles leading to further defects. The rubbing methods can also lead to uneven surface, which can result in uneven gaps between the liquid crystal and substrate.

Photoalignment layers have been developed to address some of the problems associated with rubbing methods. Notably, photoalignment methods can avoid particles left behind the surface as well as any static buildup resulting from rubbing methods. Further, photoalignment methods can avoid deformation of the substrate mentioned above. However, photoalignment methods can suffer from poor voltage holding ratio (VHR).

Typically, photoalignment layers are prepared by depositing a photoactive polymer on a substrate, which then irradiated inducing the polymeric material to align itself such that the liquid crystal disposed thereon is properly aligned, anchored and can be oriented at a certain angle. Photoactive polymers used in this approach can include photoisomerizable polymers, such as, e.g., polymers having azo groups, photodimerizable polymers, such as polymers having coumarins or cinnamate groups, photocrosslikable polymers, photodecomposable polymers such as polyimides, and the like. Photoalignment can be achieved by exposing the polymer layer to linearly polarized light.

As shown above there still exists a need for improved photoalignment materials with high alignment quality, controllable pretilt, high transmittance and good value of VHR.

### SUMMARY

The present disclosure provides a precursor compound useful in fabricating a photoalignment layer that can be used in liquid crystal devices. The precursor compound can comprise at least one anchoring group (e.g., a phosphonic acid) and at least one double C═C bond conjugated with at least one electron-withdrawing group, such as a carbonyl group, a carboxylic acid, a carboxamide, a nitrile or a ketone. The precursor compound can be coated, e.g., by dip-washing procedure, on at least one surface of a substrate [e.g., an indium tin oxide (ITO) layer] thereby forming a self-assembled layer due to anchoring via the anchoring group to the substrate surface. The self-assembled layer after irradiation, e.g., with linearly polarized UV light (in the wavelength range 250-400 nm), induces alignment of a liquid crystal in a certain direction and with variable pretilt angle, e.g., in the range from vertical alignment) (˜90° to almost planar alignment) (˜1-5°. The desired value of pretilt angle can be achieved either by varying the chemical structure of the precursor compound, or by using a mixture thereof, or by varying the dosage of UV irradiation. UV irradiation can be applied either directly on the coated substrate with self-assembled layer or onto an assembled cell, which is either empty or already charged with a liquid crystal. Using known technology for irradiation with UV light, the alignment on the substrate surface can be achieved either uniform unidirectional or patterned.

The precursor compounds described herein distinguish from cinnamate polymers known in the art by two features: (i) the precursor compounds described herein are not polymers and (ii) the precursor compounds described herein contain an anchoring group that provides reliable linking with a substrate. The anchoring described herein comprises a phosphonic acid moiety. Advantageously, the chemical structure of the precursor compounds described herein, the number of aromatic rings can be reduced to one ring (see FIG. 4 and FIG. 5) without any loss in alignment properties, thereby decreasing number of synthetic steps and reducing the net cost of materials. As the structure unit, provided photoalignment properties we have deployed additionally to commonly used cinnamates, set of other compounds possessing a double carbon-carbon bond (C═C), which is conjugated with an electron-withdrawing group, such as carbonyl, cyano, electron-deficient heterocycle ring (pyridine, pyrimidine, etc.), see FIG. 2. In this case, the the carbon-carbon double bond in the said structural environment, being attached to the surface of a substrate as a single-molecular layer, is capable of induction of alignment direction after exposure with polarized UV light. Without wishing to be bound by theory, it is hypothesized that the chemical reaction of [2+2] cycloaddition of the said activated C═C bond is primarily responsible for the induction of alignment properties.

In a first aspect, provided herein is a photoalignment layer comprising at least one precursor compound selected from the group consisting of a compound of Formula I, II, III, IV, and V:

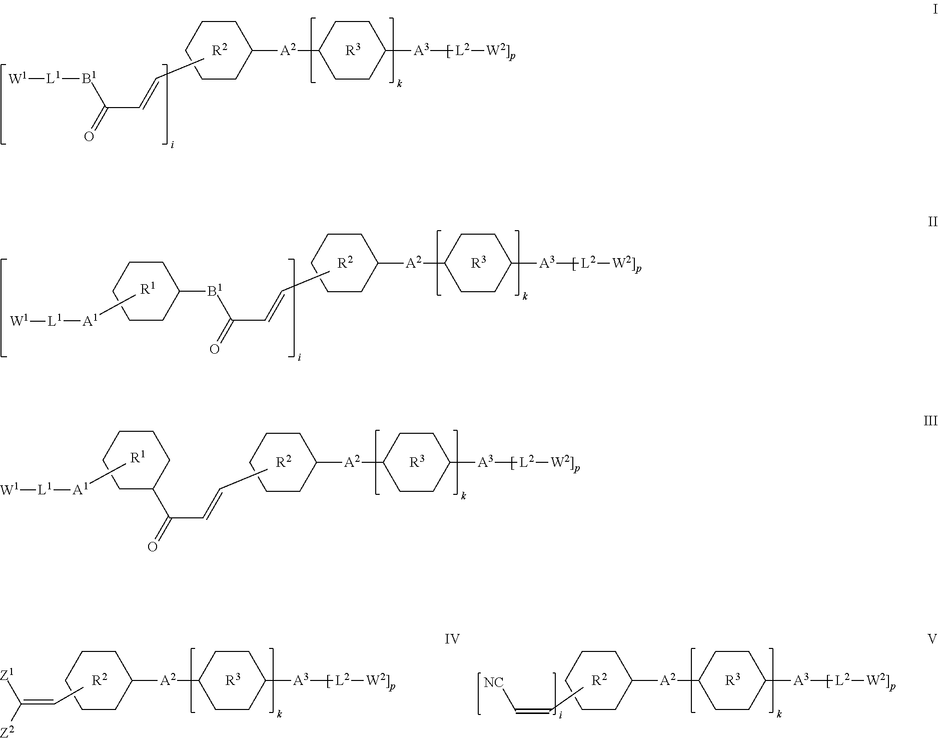

wherein:
i is 1 or 2;
k is 0 or 1;
p is 1 or 2;
R¹ is benzene-1,3-diyl or benzene-1,4-diyl, wherein R¹ is optionally substituted with one or more moieties selected from the group consisting of fluorine, chlorine, cyano, —C₁-C₁₀ alkyl, or —O—C₁-C₁₀ alkyl;
each of R² and R³ is independently selected from the group consisting of benzene-1,3-diyl, benzene-1,4-diyl, benzene-1,3,5-triyl, pyrimidine-2,5-diyl, pyridine-2,5-diyl, 2,5-thiophenylene, 2,5-furanylene, 1,4- or 2,6-naphthyle, wherein each of R² and R³ is independently optionally substituted with one or more moieties selected from the group consisting of fluorine, chlorine, cyano, —C₁-C₁₀ alkyl, or —O—C₁-C₁₀ alkyl;
W¹ is hydrogen and W² is PO(OH)₂ or W¹ is PO(OH)₂ and W² is hydrogen;
each of L¹ and L² is independently —(CH₂)₁₋₂₀-optionally substituted with one or more F; furthermore; and one or more —CH₂— is optionally independently replaced with —CF₂—, —O—, or —(C═O)— moieties provided that two O atoms are not linked together;
each of A¹, A², and A³ is independently a covalent bond, —O—, —S—, —(C═O)O—, or —O(C═O)—;
each of Z¹ and Z² is independently selected from the group consisting of a carboxylic acid, a carboxylic ester, cyano, a phosphine oxide P═O, a sulfoxide S═O, a sulfonic SO₂, a carbonyl, a pyridine, a pyrimidine, a quinoline, and a quinazoline; and
B¹ is a covalent bond, —O—, —NH—, —N(C₁-C₁₂ alkyl)-, —OCH₂—, —CH₂O—, —(C═O)O or —O(C═O)—.

In certain embodiments, the at least one precursor compound is conjugated to a surface of a substrate.

In certain embodiments, the substrate comprises a metal oxide.

In certain embodiments, the substrate is selected from the group consisting of indium tin oxide (ITO), aluminum-doped zinc oxide (AZO), indium-doped cadmium oxide (ICO), indium zinc oxide (IZO), alumina, silica, and combinations thereof.

In certain embodiments, each of i and p is 1.

In certain embodiments, R¹ is benzene-1,4-diyl optionally substituted with one or more moieties selected from the group consisting of fluorine, chlorine, cyano, —C₁-C₁₀ alkyl, or —O—C₁-C₁₀ alkyl.

In certain embodiments, each of R² and R³ is independently selected from the group consisting of benzene-1,4-diyl optionally substituted with one or more moieties selected from the group consisting of fluorine, chlorine, cyano, —C₁-C₁₀ alkyl, or —O—C₁-C₁₀ alkyl.

In certain embodiments, the at least one precursor compound is selected from the group consisting of:

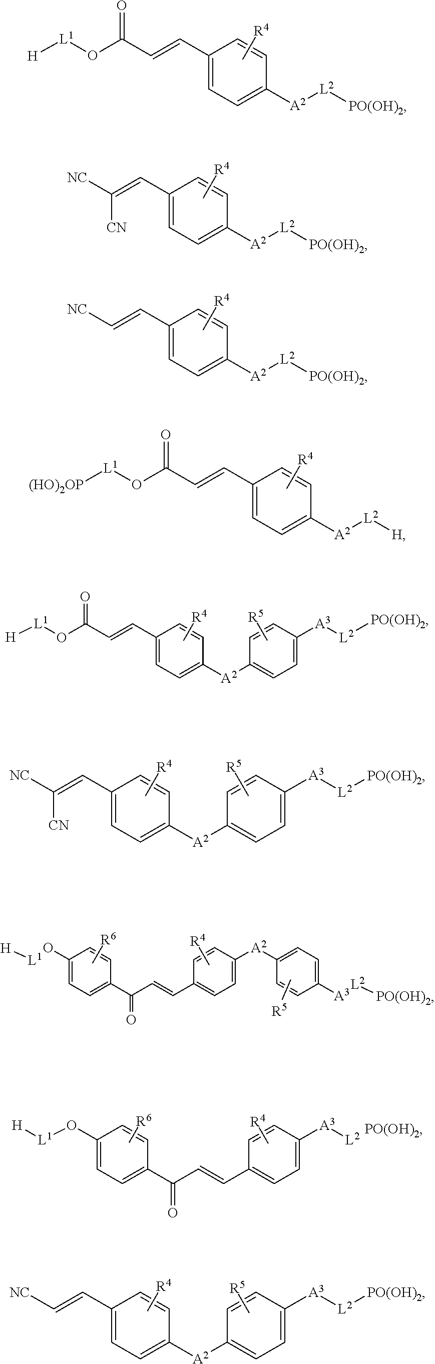

wherein:
each of A² and A³ is independently a covalent bond, —O—, —S—, —(C═O)O—, or —O(C═O)—;
each of L¹ and L² is independently —(CH₂)₁₋₂₀-optionally substituted with one or more F; furthermore; and one or more —CH₂— is optionally independently replaced with —CF₂—, —O—, or —(C═O)— moieties provided that two O atoms are not linked together; and
each of R⁴, R⁵, and R⁶ is independently hydrogen, fluorine, chlorine, cyano, —C₁-C₁₀ alkyl, or —O—C₁-C₁₀ alkyl.

In certain embodiments, each of A² and A³ is independently —O— or —O(C═O)—; each of L¹ and L² is independently —(CH₂)₆₋₁₄—; and each of R⁴, R⁵, and R⁶ is independently hydrogen or —OMe.

In certain embodiments, the at least one precursor compound is selected from the group consisting of:

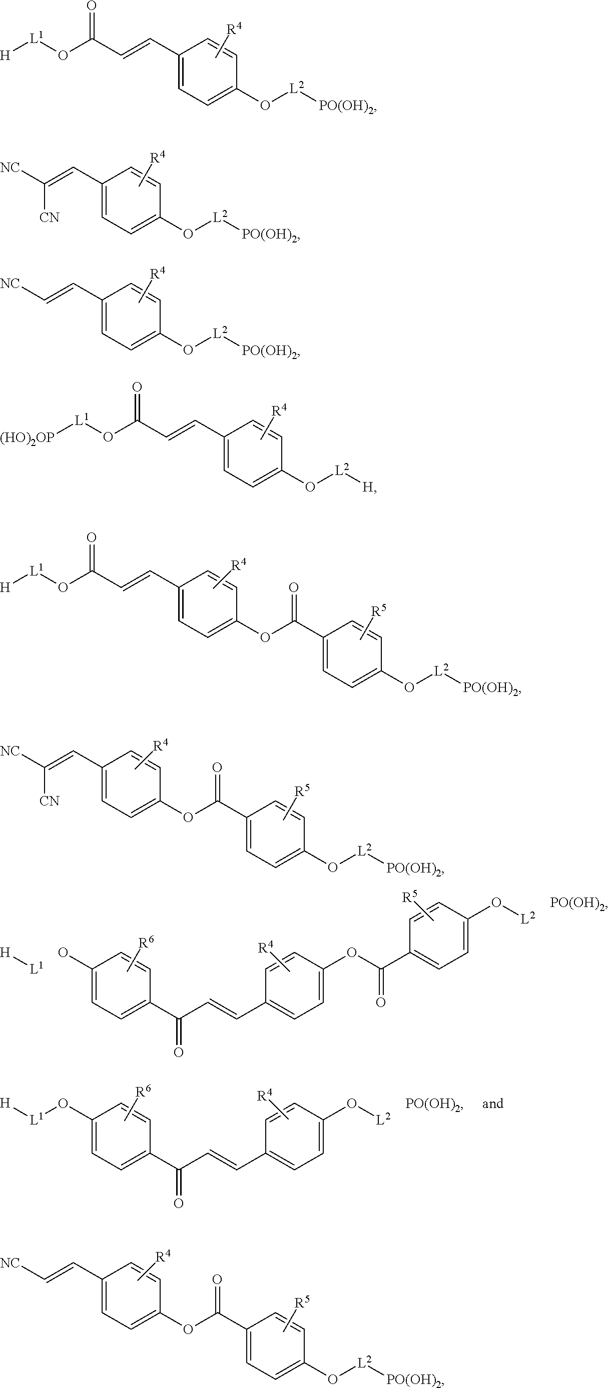

wherein:
each of L¹ and L² is independently —(CH₂)₁₋₂₀-optionally substituted with one or more F;
furthermore; and one or more —CH₂— is optionally independently replaced with —CF₂—, —O—, or —(C═O)— moieties provided that two O atoms are not linked together; and
each of R⁴, R⁵, and R⁶ is independently hydrogen, fluorine, chlorine, cyano, —C₁-C₁₀ alkyl, or —O—C₁-C₁₀ alkyl.

In certain embodiments, each of R⁴ and R⁵ is —OMe.

In certain embodiments, the at least one precursor compound is selected from the group consisting of:

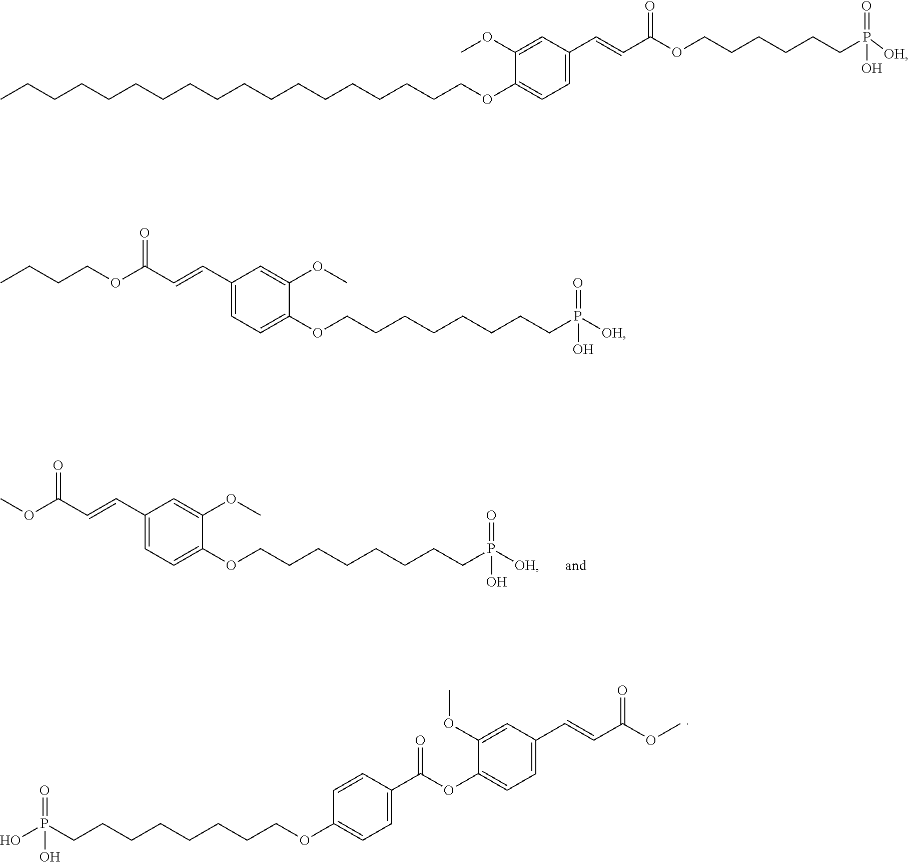 [SMILES: CCCCCCCCCCCCCCCCCCOc1ccc(/C=C/C(=O)OCCCCCCP(=O)(O)O)cc1OC ; CCCCOC(=O)/C=C/c1ccc(OCCCCCCCCP(=O)(O)O)c(OC)c1 ; COC(=O)/C=C/c1ccc(OCCCCCCCCP(=O)(O)O)c(OC)c1 ; "and" ; COC(=O)/C=C/c1ccc(OC(=O)c2ccc(OCCCCCCCCP(=O)(O)O)cc2)c(OC)c1]

In certain embodiments, the at least one precursor compound is conjugated to a surface of a substrate, wherein the substrate is indium tin oxide (ITO) or alumina.

In certain embodiments, the at least one precursor compound is two precursor compounds selected from the group consisting of a compound of Formula I, II, III, IV, and V.

In a second aspect, provided herein is a method of preparing a photoalignment layer comprising a dimerized or polymerized compound, the method comprising: providing a substrate with the photoalignment layer described herein coated on a surface of the substrate and exposing the photoalignment layer to a polarized electromagnetic radiation thereby inducing dimerizing or polymerizing the at least one precursor compound and forming the photoalignment layer comprising the dimerized or polymerized compound.

In certain embodiments, the polarized electromagnetic radiation has a wavelength of 280-400 nm.

In certain embodiments, the method further comprises depositing a composition comprising a liquid crystal on a surface of the photoalignment layer before the step of exposing the photoalignment layer to a polarized electromagnetic radiation or after the step of exposing the photoalignment layer to a polarized electromagnetic radiation.

In a third aspect, provided herein is a photoalignment layer comprising the dimerized or polymerized compound prepared according to the method described herein.

In a fourth aspect, provided herein is a photoalignment layer comprising the dimerized or polymerized compound described herein, wherein the photoalignment layer has a pretilt angle of 0-10 degrees or 80-90 degrees.

In a fifth aspect, provided herein is a liquid crystal device comprising the photoalignment layer comprising the dimerized or polymerized compound described herein and a liquid crystal layer.

Advantageously, the photoalignment layer described herein can be about 5-20 times thinner than commonly used polyimide (PI) photoalignment layers or with other photoalignment polymers. Additionally, the process of coating a substrate with the precursor compound is simpler than that of commonly used photoalignment polymers and can include dip-washing-drying process and does not require hard-baking and/or rubbing. The photoalignment layer described herein is not sensitive to overshining with UV light thereby providing a wide and reliable processing window. Starting materials used to synthesize the precursor compound are inexpensive and readily available and involve common synthetic protocols.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts the general structure of compounds I-V in accordance with certain embodiments described herein.

FIG. 2 depicts detailed structures of compounds I-V in accordance with certain embodiments described herein.

FIG. 3 depicts a general synthetic sequence of a representative precursor compound described herein comprising a phosphonic acid anchoring group and a cinnamate dimerizable or polymerizable group.

FIG. 4 depicts a general synthetic sequence of a representative precursor compound described herein comprising a phosphonic acid anchoring group and a cinnamate dimerizable or polymerizable group.

FIG. 5 depicts a general synthetic sequence of a representative precursor compound described herein comprising a phosphonic acid anchoring group and a cinnamate dimerizable or polymerizable group.

FIG. 6 depicts a schematic illustrating the oblique exposure of the treated substrates

FIG. 7 depicts the transmittance vs voltage curve (TVC) of liquid crystal cells measured before and after UV light irradiation. Light stability: the cell is put under an 8 W 425 lm lamp for 24 h. UV stability: the cell is exposed with 365 nm UV light for 2 J/cm².

FIG. 8 depicts a cross-sectional view of a photoalignment layer comprising at least one precursor compound described herein disposed on a substrate.

FIG. 9 depicts a cross-sectional view of a liquid crystal display comprising a photoalignment layer disposed on a surface of a substrate and a liquid crystal disposed on a surface of the photoalignment layer, wherein the photoalignment layer comprises the dimerized or polymerized compound prepared according to the method described herein.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the words “include”, “comprise” or variations such as “includes”, “including” “comprises” or “comprising”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As used herein, unless otherwise indicated, the term “halo” or “halide” includes fluoro, chloro, bromo or iodo.

As used herein, “alkyl” refers to a straight-chain or branched saturated hydrocarbon group. Examples of alkyl groups include methyl-, ethyl-, propyl (e.g., n-propyl and isopropyl), butyl (e.g., n-butyl, iso-butyl, sec-butyl, tert-butyl), pentyl groups (e.g., 1-methylbutyl, 2-methylbutyl, iso-pentyl, tert-pentyl, 1,2-dimethylpropyl, neopentyl, and 1-ethylpropyl), hexyl groups, and the like. In various embodiments, an alkyl group can have 1 to 40 carbon atoms (i.e., C₁-C₄₀ alkyl group), for example, 1-30 carbon atoms (i.e., C₁-C₃₀ alkyl group). In certain embodiments, an alkyl group can have 1 to 6 carbon atoms, and can be referred to as a “lower alkyl group.” Examples of lower alkyl groups include methyl, ethyl, propyl (e.g., n-propyl and isopropyl), and butyl groups (e.g., n-butyl, isobutyl, sec-butyl, tert-butyl). In certain embodiments, alkyl groups can be optionally substituted as described herein. An alkyl group is generally not substituted with another alkyl group, an alkenyl group, or an alkynyl group.

As used herein, “cycloalkyl” by itself or as part of another substituent means, unless otherwise stated, a monocyclic hydrocarbon having between 3-12 carbon atoms in the ring system and includes hydrogen, straight chain, branched chain, and/or cyclic substituents. Exemplary cycloalkyls include cyclopropyl, cyclobutyl, cyclopentyl, cyclohexyl, cycloheptyl, and the like.

The term “optionally substituted” refers to a chemical group, such as alkyl, cycloalkyl aryl, and the like, wherein one or more hydrogen may be replaced with a substituent as described herein, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like

The term “nitro” is art-recognized and refers to —NO₂; the term “halogen” is art-recognized and refers to —F, —Cl, —Br or —I; the term “sulfhydryl” is art-recognized and refers to —SH; the term “hydroxyl” means-OH; and the term “sulfonyl” and “sulfone” is art-recognized and refers to —SO₂—. “Halide” designates the corresponding anion of the halogens.

The symbol “ [symbol] ” or“ [symbol] ” or “ [symbol] ” or “ [symbol] ” in a chemical structure represents a position from where the specified chemical structure is bonded to another chemical structure.

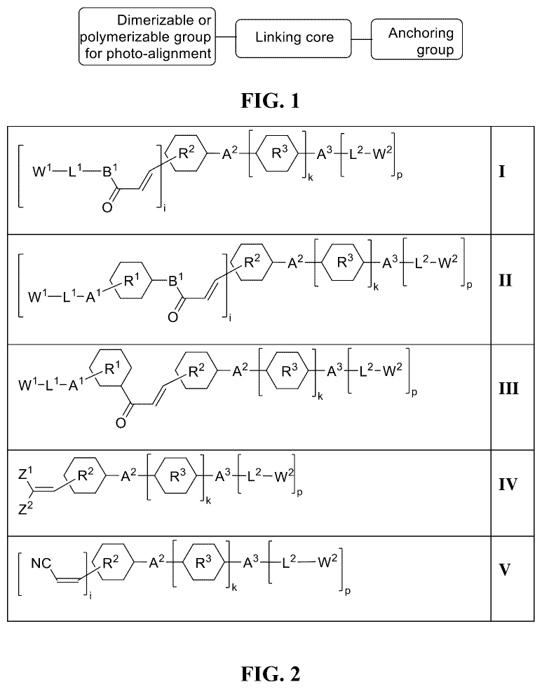

In order to provide excellent photoalignment for liquid crystal applications with controlled pretilt angle, lowers layer thickness and easy route of fabrication we propose new compounds, exemplified by derivatives of (E)-3-(4-hydroxy-3-methoxyphenyl) acrylic acid (ferulic acid or cinnamate acid derivative) with general structure shown at FIG. 1 and detailed representatives are disclosed in FIG. 2.

The present disclosure provides a photoalignment layer comprising at least one precursor compound selected from the group consisting of a compound of Formula I, II, III, IV, and V:

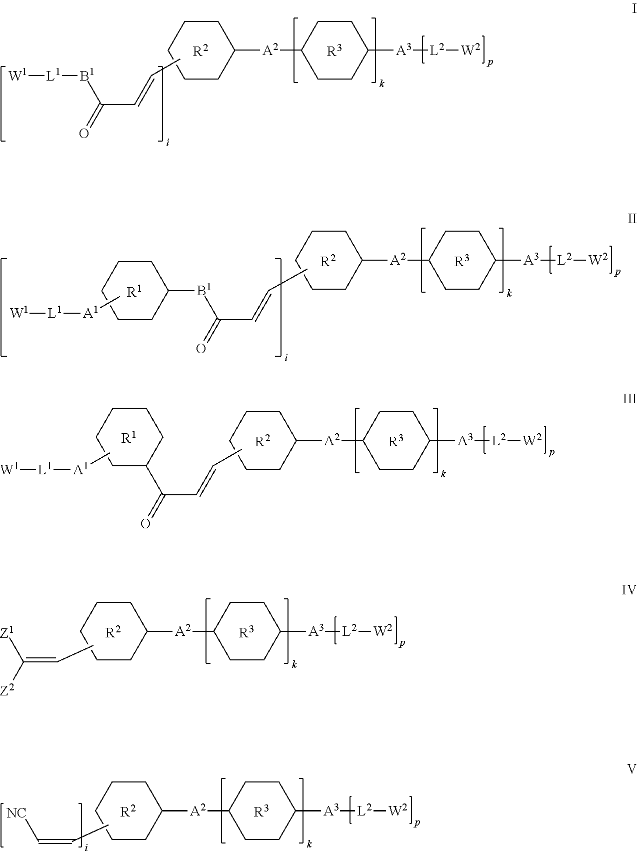

wherein:
i is 1 or 2;
k is 0 or 1;
p is 1 or 2;
R¹ is benzene-1,3-diyl or benzene-1,4-diyl, wherein R¹ is optionally substituted with one or more moieties selected from the group consisting of fluorine, chlorine, cyano, —C₁-C₁₀ alkyl, or —O—C₁-C₁₀ alkyl;
each of R² and R³ is independently selected from the group consisting of benzene-1,3-diyl, benzene-1,4-diyl, benzene-1,3,5-triyl, pyrimidine-2,5-diyl, pyridine-2,5-diyl, 2,5-thiophenylene, 2,5-furanylene, 1,4- or 2,6-naphthyle, wherein each of R² and R³ is independently optionally substituted with one or more moieties selected from the group consisting of fluorine, chlorine, cyano, —C₁-C₁₀ alkyl, or —O—C₁-C₁₀ alkyl;
W¹ is hydrogen and W² is PO(OH)₂ or W¹ is PO(OH)₂ and W² is hydrogen;
each of L¹ and L² is independently —(CH₂)₁₋₂₀-optionally substituted with one or more F; furthermore; and one or more —CH₂— is optionally independently replaced with —CF₂—, —O—, or —(C═O)— moieties provided that two O atoms are not linked together;
each of A¹, A², and A³ is independently a covalent bond, —O—, —S—, —(C═O)O—, or —O(C═O)—;
each of Z¹ and Z² is independently selected from the group consisting of a carboxylic acid, a carboxylic ester, cyano, a phosphine oxide P═O, a sulfoxide S═O, a sulfonic SO₂, a carbonyl, a pyridine, a pyrimidine, a quinoline, and a quinazoline; and
B¹ is —O—, —NH—, or —N(C₁-C₁₂ alkyl)-.

In certain embodiments, R¹ is represented by a moiety selected from the group consisting of:

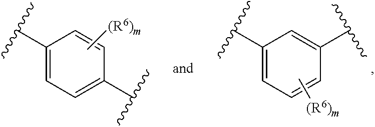

wherein m is 1, 2, or 3; and R⁶ for each instance is independently fluorine, chlorine, cyano, —C₁-C₁₀ alkyl, —O—C₁-C₁₀ alkyl, —O—C₁-C₈ alkyl, —O—C₁-C₆ alkyl, —O—C₁-C₄ alkyl, —O—C₁-C₂ alkyl, or —OMe.

In certain embodiments, R² is selected from the group consisting of:

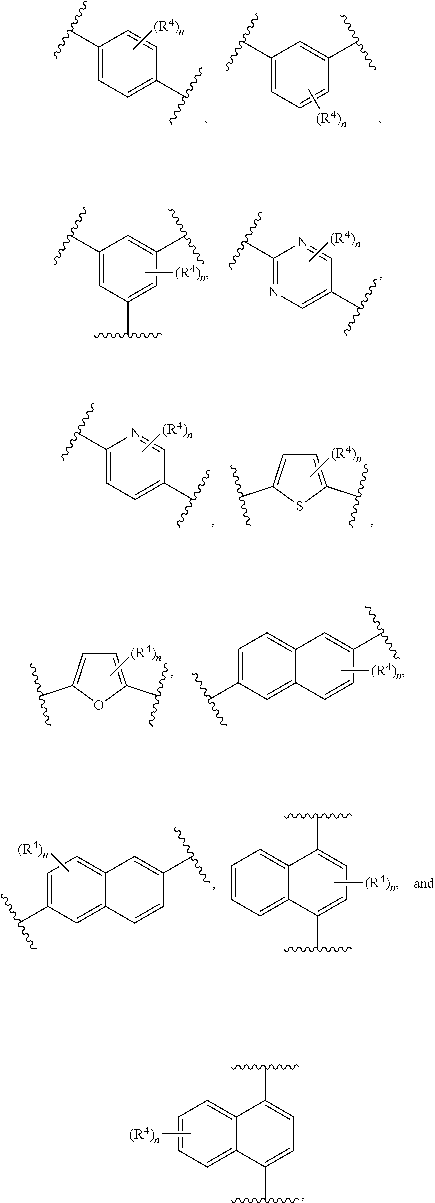

wherein n is 1, 2, or 3; and R⁴ for each instance is independently is fluorine, chlorine, cyano, —C₁-C₁₀ alkyl, —O—C₁-C₁₀ alkyl, —O—C₁-C₈ alkyl, —O—C₁-C₆ alkyl, —O—C₁-C₄ alkyl, —O—C₁-C₂ alkyl, or —OMe.

In certain embodiments, R² is

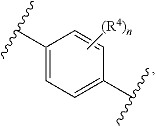

wherein n is 1 and R⁴ is —C₁-C₁₀ alkyl, —O—C₁-C₁₀ alkyl, —O—C₁-C₈ alkyl, —O—C₁-C₆ alkyl, —O—C₁-C₄ alkyl, —O—C₁-C₂ alkyl, or —OMe.

In certain embodiments, R³ is selected from the group consisting of:

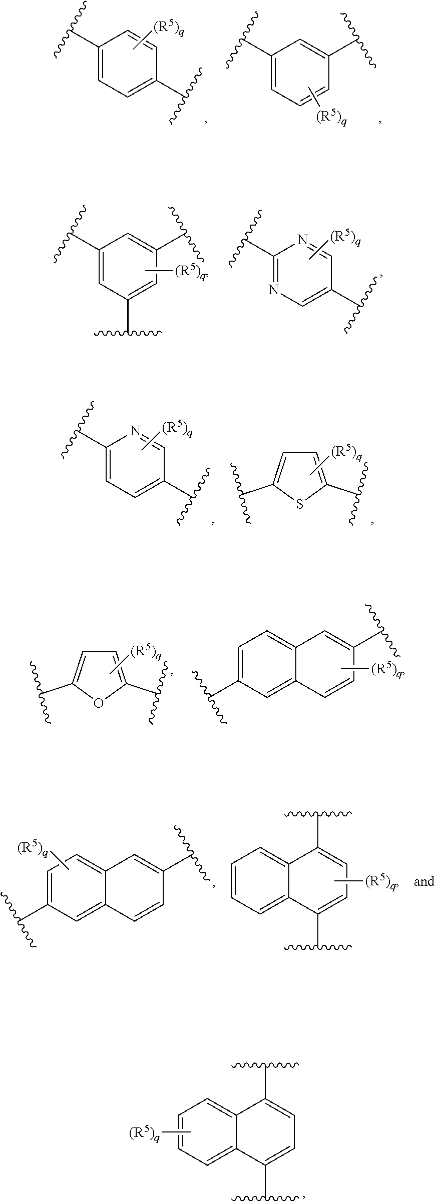

wherein q is 1, 2, or 3; and R⁵ for each instance is independently fluorine, chlorine, cyano, —C₁-C₁₀ alkyl, —O—C₁-C₁₀ alkyl, —O—C₁-C₈ alkyl, —O—C₁-C₆ alkyl, —O—C₁-C₄ alkyl, —O—C₁-C₂ alkyl, or —OMe.

In certain embodiments, R³ is

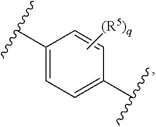

wherein q is 1 and R⁵ is —C₁-C₁₀ alkyl, —O—C₁-C₁₀ alkyl, —O—C₁-C₈ alkyl, —O—C₁-C₆ alkyl, —O—C₁-C₄ alkyl, —O—C₁-C₂ alkyl, or —OMe.

Each of L¹ and L² can independently be —(CH₂)ₜ—, wherein t is a whole numbers selected from 1-20, 1-18, 1-16, 1-14, 1-12, 1-10, 1-8, 1-6, 1-4, 1-2, 2-20, 4-20, 6-20, 8-20, 10-20, 12-20, 14-20, 16-20, 18-20, or 6-18 wherein —(CH₂)ₜ— is optionally substituted with one or more F; furthermore; and one or more —CH₂— is optionally independently replaced with —CF₂—, —O—, or —(C═O)— moieties provided that two O atoms are not linked together forming a peroxide moiety (—O—O—). In certain embodiments each of L¹ and L² is independent 6-8 or 12-20.

In certain embodiments, each of A¹, A², and A³ is independently a covalent bond, —O—, —S—, —(C═O)O—, or —O(C═O)—. In certain embodiments, A² is —O— or —O(C═O)—; and A³ is —O—. In the interest of clarity, when A¹, A², and A³ is a covalent in, for example, the precursor compound of Formula III can be represented by the structure:

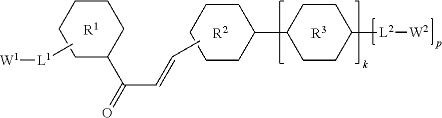

Each of Z¹ and Z² is independently selected from the group consisting of a carboxylic acid, a carboxylic ester (such as a carboxylic-C₁-C₁₀ alkyl ester), cyano, a phosphine oxide P═O (such as a C₁-C₁₀ dialkyl phosphine oxide) a sulfoxide S═O (such as a —C₁-C₁₀ alkyl sulfoxide), a sulfonic SO₂ (such as a carboxylic C₁-C₁₀ sulfonic ester), a carbonyl (such as a —C₁-C₁₀ alkyl carbonyl), a pyridine (such as pyridin-2-yl or pyridin-4-yl), a pyrimidine (such as pyrimidin-2-yl or pyrimidin-4-yl), a quinoline (such as quinolin-2-yl), and a quinazoline (quinazolin-2-yl). In certain embodiments, each of Z¹ and Z² is independently selected from the group consisting —CO₂H, —CO₂ (C₁-C₂₀ alkyl), —CO₂ (C₁-C₁₈ alkyl), —CO₂ (C₁-C₁₆ alkyl), —CO₂ (C₁-C₁₄ alkyl), —CO₂ (C₁-C₁₂ alkyl), —CO₂ (C₁-C₁₀ alkyl), —CO₂ (C₁-C₈ alkyl), —CO₂ (C₁-C₆ alkyl), —CO₂ (C₁-C₄ alkyl), —CO₂ (C₁-C₁ alkyl), or —CN.

In certain embodiments, B¹ is —O—, —NH—, —N(C₁-C₁₂ alkyl)-, —N(C₁-C₁₀ alkyl)-, —N(C₁-C₈ alkyl)-, —N(C₁-C₆ alkyl)-, —N(C₁-C₄ alkyl)-, or —N(C₁-C₂ alkyl)-. In certain embodiments, B¹ is —O—.

In certain embodiments, the at least one precursor compound is selected from the group consisting of:

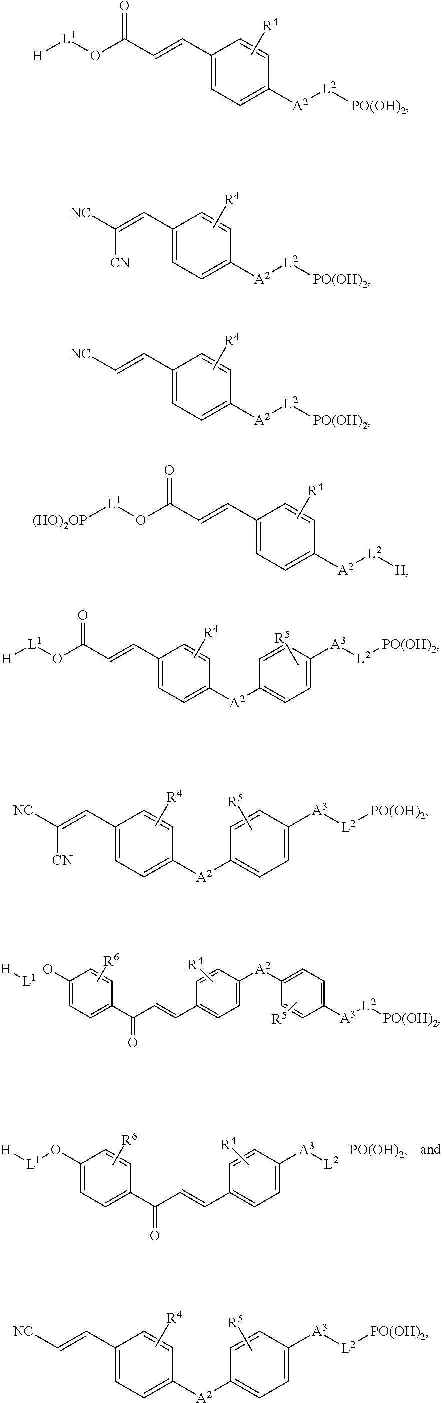

wherein each of A², A³, L¹, L², R⁴, R⁵, and R⁶ is independently as defined in any embodiment or combination of embodiments described herein.

In certain embodiments, the at least one precursor compound is selected from the group consisting of:

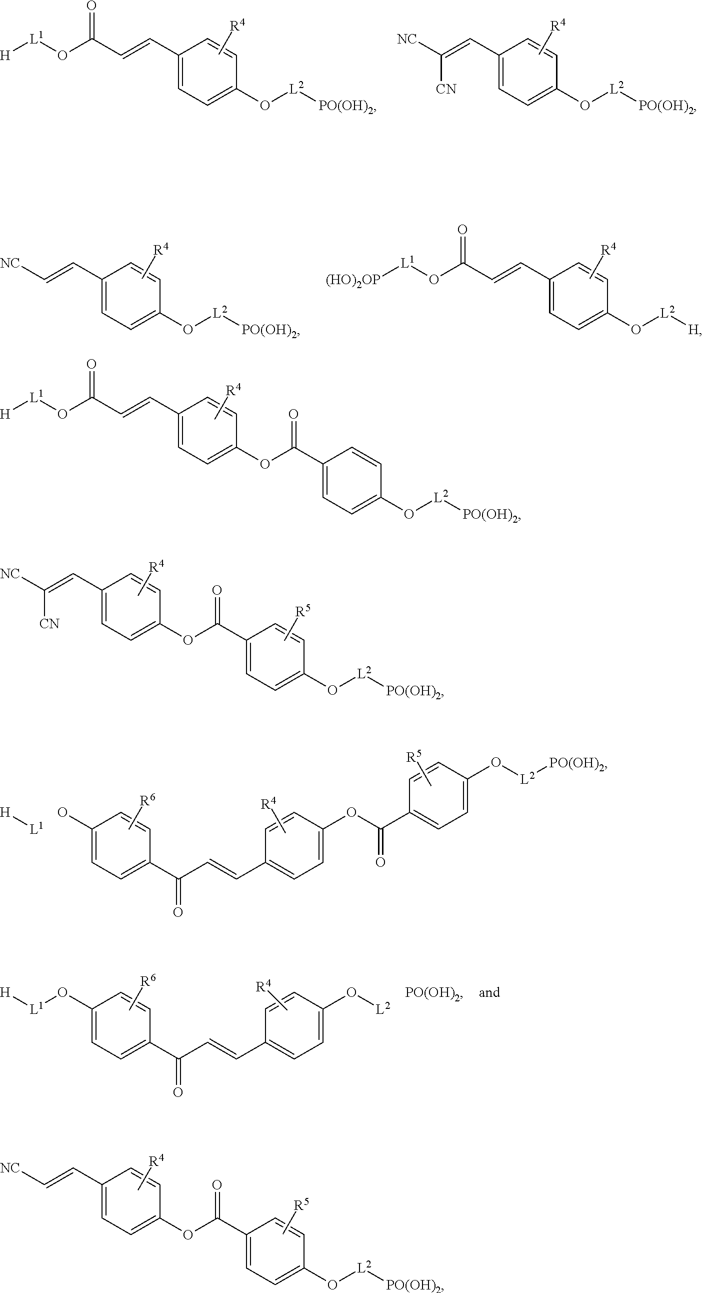

wherein each of L¹, L², R⁴, R⁵, and R⁶ is independently as defined in any embodiment or combination of embodiments described herein.

In certain embodiments, the at least one precursor compound is selected from the group consisting of:

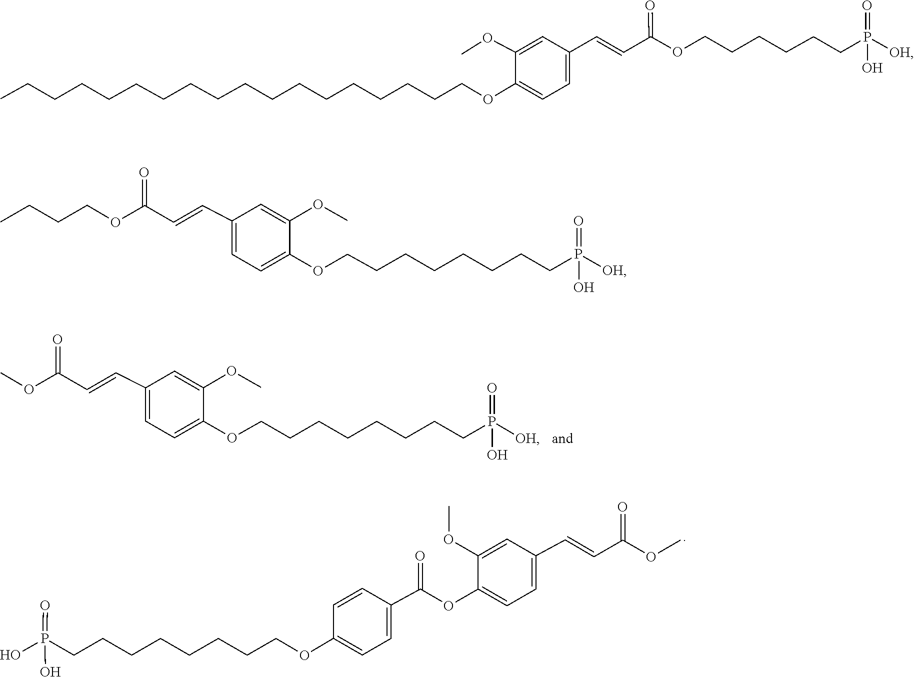 [SMILES: CCCCCCCCCCCCCCCCCCOc1ccc(/C=C/C(=O)OCCCCCCP(=O)(O)O)cc1OC ; CCCCOC(=O)/C=C/c1ccc(OCCCCCCCCP(=O)(O)O)c(OC)c1 ; COC(=O)/C=C/c1ccc(OCCCCCCCCP(=O)(O)O)c(OC)c1 ; COC(=O)/C=C/c1ccc(OC(=O)c2ccc(OCCCCCCCCP(=O)(O)O)cc2)c(OC)c1]

In certain embodiments, the at least one precursor compound is conjugated to a surface of a substrate. In certain embodiments, the substrate comprises a metal or conductive metal oxide. Exemplary metals and conductive metal oxides include, but are not limited to aluminum, gold, silver, and indium-tin oxide (ITO), aluminum-doped zinc oxide (AZO), indium-doped cadmium oxide (ICO), indium zinc oxide (IZO), alumina, silica, and combinations thereof. In certain embodiments, the substrate is ITO.

The at least one precursor compound can be conjugated to the surface of a substrate via one or more of a covalent bond, a hydrogen bond, a dative bond, an ionic bond, or combination thereof between the phosphonic acid moiety and the substrate surface. In certain embodiments, the conjugation of the phosphonic acid moiety and the substrate surface can be represented by any one or more of the following chemical structures:

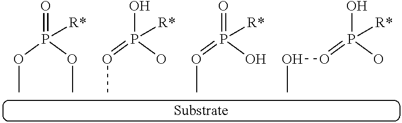

wherein R* is L¹ or L².

The precursor compounds described herein have notable advantages comparing to polymers described before:
1. Easier way to synthesize. Less steps than in route of polymer preparation.
2. Easier way to purify. All half products and final compounds can be easy purified by flash chromatography or recrystallization.
3. The absence of polymerizable groups makes them more stable, no necessary to use an inhibitor for storage.
4. For making alignment monolayer enough to deep sample in solution of the said new compound for even as short as 10 sec and further remove an excess of unbound alignment materials by washing the substrate with the same solvent, optionally under sonication.
5. Alignment layer thickness is approximately 5 nm, what is much lower than was done before.
6. Excellent vertical or planar alignment, depending on chemical structure of alignment materials.
7. The desired value of pretilt angle of LC is achieved either by varying the chemical structure of the said photo-alignment materials, or by using mixture thereof, or by varying the dosage of UV irradiation.
8. High value of VHR, which can reach 98% at frame rate of 60 Hz

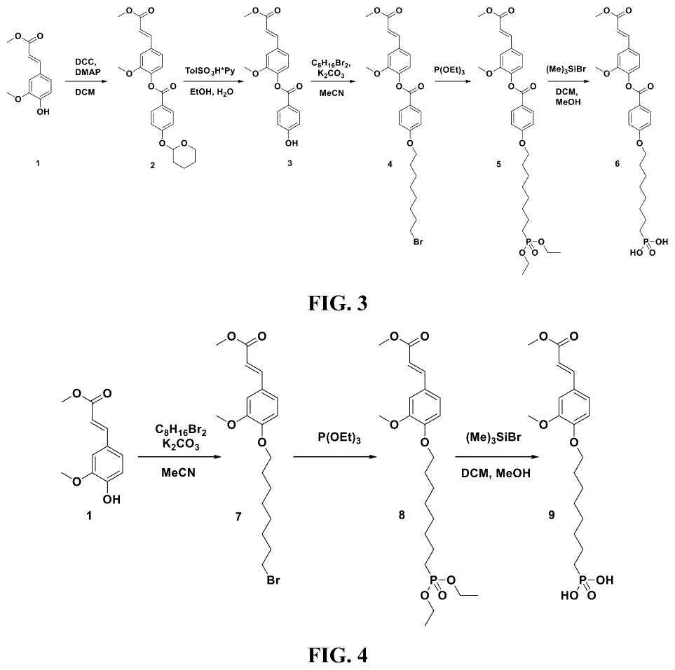

An exemplary scheme of synthesizing a precursor compound comprising a phosphonic acid functional group with several benzene rings (see FIG. 3) can include the following steps (using ferrulic acid as an example):
1. Acylation of ferulic ester by OH-protected benzoic acid.
2. Deprotection of OH group.
3. Alkylation of OH group of former benzoic acid ring by dibromo alkane.
4. Converting Br to phosphonic ester (Michaelis-Arbuzov reaction);
5. Hydrolysis of phosphonic ester.

The scheme of synthesis of simplified structure of new alignment materials bearing single benzene ring (see FIG. 4) is similar to those shown in FIG. 3, but starts from 3rd steps.

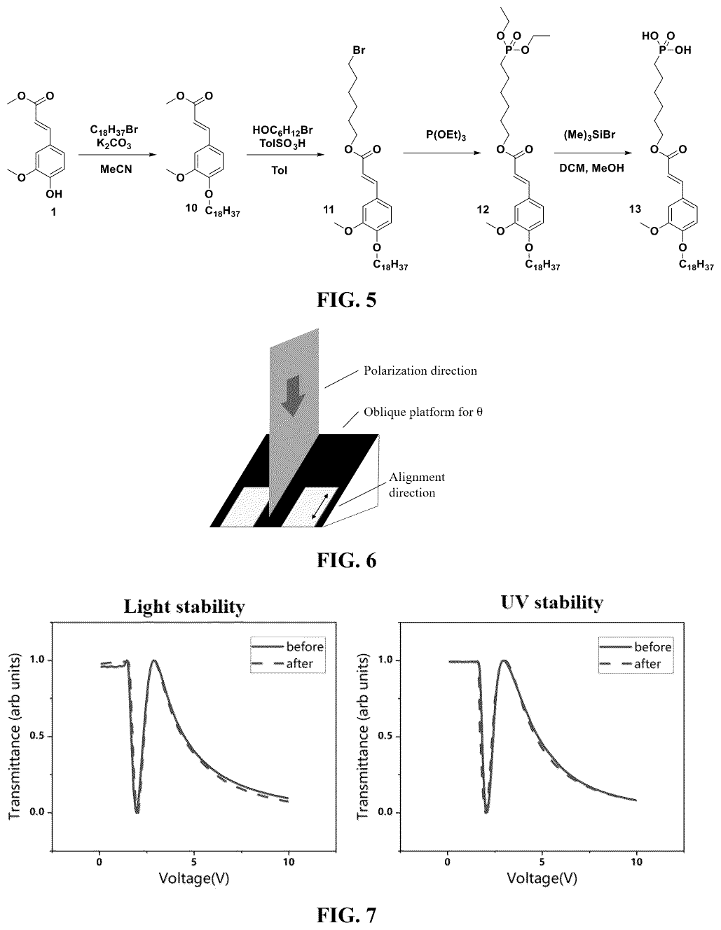

The scheme of synthesis of “reverse” cinnamate phosphonic acid derivatives where activated C═C bond and phosphonic acid group are on the same site of benzene ring (see FIG. 5) includes following steps:
1. Alkylation of OH group by bromo alkane.
2. Interesterification with bromo alcohol.
3. Converting Br to phosphonic ester (Michaelis-Arbuzov reaction).
4. Hydrolysis of phosphonic ester.

Advantageously, the impurities that form during the synthetic steps have different enough solubilities than the at least one precursor compound allowing for convenient purification of the desired compound. Therefore, to obtain the intermediate products and final phosphonic acids in high purity, two simple steps are enough: flash-chromatography of the crude half products on short plug of silica gel and by re-crystallization from an appropriate solvent, which is exemplified in Examples 1-15.

The present disclosure also provides a method of preparing a photoalignment layer comprising a dimerized or polymerized compound, the method comprising: providing a substrate with the photoalignment layer described herein coated on a surface of the substrate and exposing the photoalignment layer to a polarized electromagnetic radiation thereby inducing dimerizing or polymerizing the at least one precursor compound and forming the photoalignment layer comprising the dimerized or polymerized compound.

Irradiating the photoalignment layer comprising the at least precursor compound with polarized electromagnetic radiation induces [2+2] cycloaddition dimerization reactions of the at least one precursor compounds comprising a single olefin moiety. In instances in which the at least one precursor compounds comprise more than one olefin moiety, irradiating photoalignment layer induces [2+2] cycloaddition polymerization reactions.

Advantageously, adjusting the intensity and duration of the polarized electromagnetic radiation of the photoalignment layer can modify the pretilt angle of the resulting photoalignment layer comprising the dimerized or polymerized compound.

The polarized electromagnetic radiation can have a wavelength of 280-400 nm.

In certain embodiments, the method further comprises depositing a composition comprising the at least one precursor compound described herein and a solvent on a surface of a substrate thereby forming the photoalignment layer coated on the surface of the substrate; and optionally removing the solvent.

The solvent is not particularly limited and can be any solvent in which the at least one precursor compound described herein is at least partially soluble. In certain embodiments, the solvent is an amide, formamide, a phosphoramide, haloalkane, ether, an aromatic solvent, an ester, an alcohol, dialkyl sulfoxide, or a combination thereof. Exemplary solvents include, but are not limited to, N-methyl-2-pyrrolidone (NMP), ethanol, ethyl acetate, tetrahydrofuran, toluene, and combinations thereof.

The solvent can be removed using any method known in the art, such as the application of heat, vacuum, or a combination thereof.

The substrate can comprise a conductive metal oxide, such as ITO, AZO, ICO, IZO, alumina, silica, and combinations thereof. In certain embodiments, the substrate comprises ITO.

Also provided herein is the photoalignment layer comprising the at least one precursor disposed on at least one surface of a substrate.

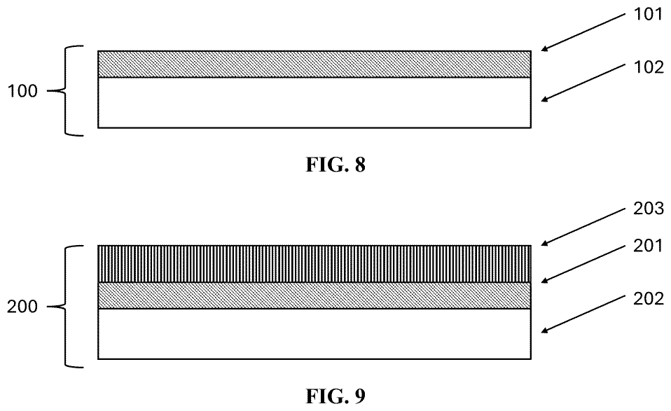

FIG. 8 depicts a cross-sectional view of an exemplary bilayer (100) comprising the photoalignment layer comprising at least one precursor compound described herein (101) disposed on a surface of a substrate (102).

In certain embodiments, the method further comprises depositing a composition comprising a liquid crystal on a surface of the photoalignment layer before the step of exposing the photoalignment layer to a polarized electromagnetic radiation or after the step of exposing the photoalignment layer to a polarized electromagnetic radiation.

Also provided herein is a photoalignment layer comprising the dimerized or polymerized compound prepared according to the methods described herein.

FIG. 9 depicts a cross-sectional view of an exemplary liquid crystal display (200) comprising a photoalignment layer (201) disposed on a surface of a substrate (202) and a liquid crystal (203) disposed on a surface of the photoalignment layer, wherein the photoalignment layer comprises the dimerized or polymerized compound prepared according to the method described herein.

In certain embodiments, the photoalignment layer comprising the dimerized or polymerized compound has a pretilt angle of 0-10 degrees or 80-90 degrees. In certain embodiments, the photoalignment layer comprising the dimerized or polymerized compound has a pretilt angle of about 0-2 degrees and about 86 degrees.

The proposed new way of modifying surface allows to achieve monomolecular alignment layer with excellent alignment.

### EXAMPLES

### Synthesis of the Alignment Precursor Compounds

### Example 1—Synthesis of (E)-2-methoxy-4-(3-methoxy-3-oxoprop-1-en-1-yl)phenyl 4-((tetrahydro-2H-pyran-2-yl)oxy)-benzoate [Compound 2]

To a cooled (ice-water), stirred solution of 3.50 g (15.8 mmol) of 4-((tetrahydro-2H-pyran-2-yl)oxy)benzoic acid, 3.64 g (17.5 mmol) of methyl (E)-3-(4-hydroxy-3-methoxyphenyl) acrylate and 5 mg of 4-N,N-dimethylaminopyridine in 30 ml of dichloromethane (DCM) was added dropwise solution of 3.60 g (17.5 mmol) of dicyclohexyl-carbodiimide (DCC) in 20 ml of dry DCM. After finishing addition, the mixture was stirred while reaction is completed (monitoring by TLC), then precipitation was filtered off and washed additionally with 100 ml of DCM. Combined solutions in DCM were evaporated to dryness, dissolved in toluene, and purified by flash chromatography on SiO₂ using toluene as an eluent top yield a colorless oil. The colorless oil was crystallized from isopropyl alcohol (IPA) in fridge. Yield 78% (5.1 g) of a white amorphous powder.

### Example 2—Synthesis of (E)-2-methoxy-4-(3-methoxy-3-oxoprop-1-en-1-yl)phenyl 4-hydroxybenzoate [Compound 3]

To a hot, stirred solution (60° C.) of 4.50 g (10.9 mmol) (E)-2-methoxy-4-(3-methoxy-3-oxoprop-1-en-1-yl)phenyl 4-((tetrahydro-2H-pyran-2-yl)oxy)benzoate in 100 ml ethanol and 5 ml H₂O was added 0.55 g (2.2 mmol) of pyridinium salt of toluene sulfonic acid. Solution was stirred at 60° C. while reaction is completed (monitoring by TLC). After ¾ of solvent was evaporated and rest of the solution was poured on ice to yield a white gum-like precipitate. The white gum-like precipitate was washed by 100 ml cold water. Yield 98% (3.54 g).

### Example 3 Synthesis of (E)-2-methoxy-4-(3-methoxy-3-oxoprop-1-en-1-yl)phenyl 4-((8-bromooctyl)oxy)benzoate [Compound 4]

A mixture of 2.50 g (7.6 mmol) (E)-2-methoxy-4-(3-methoxy-3-oxoprop-1-en-1-yl)phenyl 4-hydroxybenzoate, 14.50 g (53.4 mmol) 1,8-dibromooctane and 4.20 g (30.4 mmol) potassium carbonate in 75 ml acetonitrile was refluxed for 3 hours. After cooling the inorganic part was filtered off and washed by an additional 50 ml of acetonitrile. The combined solutions were evaporated and recrystallized twice from IPA and hexane. Yield 86% (3.39 g) of white powder.

### Example 4—Synthesis of (E)-2-methoxy-4-(3-methoxy-3-oxoprop-1-en-1-yl)phenyl 4-((8-(diethoxyphosphoryl)-octyl)oxy)benzoate [Compound 5]

A solution of 2 g (3.9 mmol) (E)-2-methoxy-4-(3-methoxy-3-oxoprop-1-en-1-yl)phenyl 4-((8-bromooctyl)oxy)benzoate in 25 ml of triethyl phosphite was degassed and refluxed in azote atmosphere for 8 h. After excess triethyl phosphite was removed under vacuum to yield a colorless oil, which was solidified after cooling to room temperature with quantitative yield.

### Example 5—Synthesis of (E)-(8-(4-((2-methoxy-4-(3-methoxy-3-oxoprop-1-en-1-yl) phenoxy) carbonyl) phenoxy) octyl) phosphonic acid [Compound 6]

To a cooled by ice stirred solution of 2.2 g (3.8 mmol) of (E)-2-methoxy-4-(3-methoxy-3-oxoprop-1-en-1-yl)phenyl 4-((8-(diethoxyphosphoryl) octyl)oxy) benzoate in 30 ml of DCM 0.87 g (5.7 mmol) of trimethylsilyl bromide was added dropwise. Solution was stirred 8 hours. After DCM was evaporated to dryness and 30 ml of methanol was added. Solution was kept under stirring 8 hours more. After methanol was removed on rotary evaporator and product recrystallized from IPA in fridge as white powder. Yield 90% (1.79 g).

### Example 6—Synthesis of methyl (E)-3-(4-((8-bromooctyl)oxy)-3-methoxyphenyl) acrylate [Compound 7a]

The synthesis of Compound 7a was carried out essentially following to the protocol described in Example 3. Excess alkylating agent was removed by flash chromatography using hexane as eluent. Product was eluted by toluene and recrystallized from IPA in fridge. Yield 64% (3.66 g).

### Example 7 Methyl (E)-3-(4-((8-(diethoxyphosphoryl) octyl)oxy)-3-methoxyphenyl) acrylate [Compound 8a]

The synthesis of compound 8a was carried out essentially following the protocol described in Example 4 with quantitative yield.

### Example 8—Synthesis of (E)-(8-(2-methoxy-4-(3-methoxy-3-oxoprop-1-en-1-yl) phenoxy) octyl)phosphonic acid [Compound 9a]

The synthesis of Compound 9a was carried out essentially following the protocol described in Example 5 with 81% yield.

### Example 9 Synthesis of butyl (E)-3-(4-(8-bromooctyl)oxy)-3-methoxyphenyl) acrylate [Compound 7b]

The synthesis of Compound 7b was carried out essentially following the protocol described in Example 3 with 58% yield.

### Example 10—Synthesis of butyl (E)-3-(4-((8-(diethoxyphosphoryl) octyl)oxy)-3-methoxyphenyl) acrylate [Compound 8b]

The synthesis of Compound 8b was carried out essentially following the protocol described in Example 4 with quantitative yield.

### Example 11—Synthesis of (E)-(8-(4-(3-butoxy-3-oxoprop-1-en-1-yl)-2-methoxyphenoxy) octyl)phosphonic acid [Compound 9b]

The synthesis of Compound 9b was carried out essentially following the protocol described in Example 5. Product was recrystallized from hexane with 77% yield.

### Example 12—Synthesis of methyl (E)-3-(3-methoxy-4-(octadecyloxy)phenyl) acrylate [Compound 10]

The synthesis of Compound 10 was carried out essentially following the protocol described in Example 3, recrystallized from acetonitrile with 95% yield.

### Example 13 Synthesis of 6-bromohexyl (E)-3-(3-methoxy-4-(octadecyloxy)phenyl) acrylate [Compound 11]

A solution of 1.5 g Methyl (E)-3-(3-methoxy-4-(3.3 mmol) (octadecyloxy)phenyl) acrylate, 1.8 g (9.9 mmol) 6-bromo-1-hexanol and catalytic amount of toluene sulfonic acid (˜50 mg) were refluxed 48 hours. After reaction complete solution were filtered through silica gel with toluene as eluent. After toluene was evaporated on rotary evaporator and product was recrystallized from 50 ml of acetonitrile with 83% yield (1.65 g).

### Example 14—Synthesis of 6-(diethoxyphosphoryl) hexyl (E)-3-(3-methoxy-4-(octadecyloxy)phenyl) acrylate [Compound 12]

The synthesis of Compound 12 was carried out essentially following the protocol described in Example 4 with quantitative yield.

### Example 15—Synthesis of (E)-(6-((3-(3-methoxy-4-(octadecyloxy)phenyl) acryloyl)oxy) hexyl)phosphonic acid [Compound 13]

The synthesis of Compound 13 was carried out essentially following the protocol described in Example 5. Product was recrystallized from isopropyl alcohol with 78% yield.

### Example 16—Precursor Compound Deposition

Preparation of a solution The concentration of the precursor compound varied from 0.1˜0.5 wt/wt %. The precursor compound or mixture thereof were dissolved in an appropriate solvent by adding the solvent to a sample of the precursor compound and stirring for at least 10 min to complete dissolution. The appropriate solvents preferably provide enough solubility at the desired concentration, do not chemically react with the precursor compound and can be selected but not limited from the following list: N-methyl-2-pyrrolidone (NMP), ethanol, ethyl acetate, tetrahydrofuran, toluene, and mixtures thereof.

Treatment of the substrate Substrates coated with ITO or alumina (Al₂O₃) were cleaned in the usual manner typically used for substrate cleaning for LC cells, and then treated with ozone. Then, the substrates were dipped into the solution prepared described above for several seconds, typically for 5-10 seconds. Then, the dipped substrate was twice washed in the same solvent that was used for dissolving the precursor compound (each time is approx. for 10 min), optionally assisted with sonicating washing bath at ambient temperature. Finally, the residual solvent after washing was removed by soft baking the substrate at 100° C. for 20 min, optionally, in the vacuum chamber at pressure of 100 mbar or lower.

Thereafter, the prepared substrate was treated with UV light to provide alignment. Three kinds of treatments were applied: The substrates are tilted by angle θ within the range of 10 to 80 degree along the polarization direction, preferably within 40-50 degree, most preferably at 45° along the direction of polarized light, see FIG. 6, and exposed with the said polarized light at 310-360 nm wavelength, at total energy within 14-850 mJ/cm², preferably within 250-400 mJ/cm² (measured at 310 nm). For example, a high-pressure mercury lamp with filtered polarized output (1.13 mW/cm² at 310 nm, 1.9 mW/cm² at 365 nm) was used to irradiate the substrates with a total duration within 12-750 s, preferably within 220-360 s. A nematic liquid crystal is injected into the said cell by capillary forces at ambient pressure and temperature.
1. The substrates were assembled into cells prior to exposure with polarized light. Then, irradiation with polarized light is carried out similarly as it was described above: the cells are tilted by said angle along the polarized light direction and exposed for the said dosage. A nematic liquid crystal was then injected into the cell by capillary forces at ambient pressure and temperature.
2. The substrates were assembled into cells and charged with a liquid crystal prior exposure with polarized light. The substrates were then assembled into cells in the usual manner and nematic liquid crystal was injected into the cell by capillary forces at elevated temperature, preferably at 5° C. higher than the clearing point temperature of the liquid crystal. In this case, the design of electrodes on the substrates and the type of liquid crystal should meet the requirement that the phase retardation along the normal direction of the substrate can be almost eliminated if the cell is applied with large enough electric filed. The cell is applied with strong enough electric field and irradiation with polarized light for certain time. During the process, 0 is 0°.

### Example 17—Studying of Properties of LC Cells Example 16

The cell was injected with a nematic liquid crystal containing 3 wt % of dichroic dye (N-methyl-4-((2-methyl-4-((3′-methyl-4′-((4-(butyloxy)phenyl)diazenyl)-[1,1′-biphenyl]-4-yl)diazenyl)phenyl)diazenyl)-N-octyl-aniline). The dichroic ratio of the LC cell is measured by spectrometer equipped with a linear polarizer. The cell was then placed onto a rotational holder and the position of rotation was found when absorbance at 490 is minimal (Dₘᵢₙ) and maximal (Dₘₐₓ). Then the dichroic ratio was calculated as DR=Dₘₐₓ/Dₘᵢₙ. The order parameter(S) was calculated accordingly to the following equation S═(DR−1)/(DR+2). The S is within the range 0.6-0.7.

### Example 18—VHR Measurement

VHR was measured by an electro-optical setup at 60° C., by applying a 5V pulse following to the method described in [Tseng M. C., Yaroshchuk O., Bidna T., Srivastava A. K., Chigrinov V., Kwok H. S. Strengthening of liquid crystal photoalignment on azo dye films: Passivation by reactive mesogens. RSC Advances. 2016, 6, 48181-48188]. Then, the VHR value was calculated as a relative decreasing the voltage measured after 16.7 ms to that after 5 ms of pulse applying. The measured VHR values was not lower than 98%.

### Example 19—Residual Direct Circuit (RDC) Voltage Measurement

For measuring RDC voltage, a 10 V DC signal was applied to the LC cell for 1 hour at 60° C. Then the cell was disconnected and short-circuited for 1 s to discharge the LC capacitor, following the standard definition stated in [Guo Q., Srivastava A. K., Chigrinov V. G., Kwok H. S. Polymer and azo-dye composite: A photoalignment layer for liquid crystals. Liquid Crystals. 2014, 41, 1465-1472]. Thereafter, the residual voltage was measured after 10 min. The value was ˜6 mV.

| | | Pretilt, | VHR, | RDC, |
|---|---|---|---|---|
| No | Structure | ° | % | mV |
| Compound 6 | 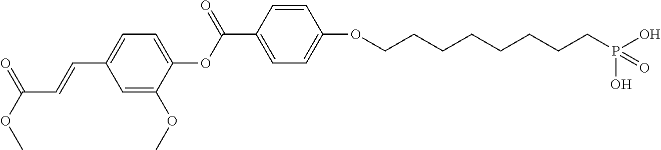 [SMILES: COC(=O)/C=C/c1ccc(OC(=O)c2ccc(OCCCCCCCCP(=O)(O)O)cc2)c(OC)c1] | 0-2 | 98.9 | 7.2 |
| Compound 9a | 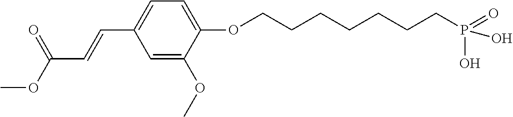 [SMILES: COC(=O)/C=C/c1ccc(OCCCCCCCP(=O)(O)O)c(OC)c1] | 0-2 | 99.3 | 5.4 |
| Compound 9b | 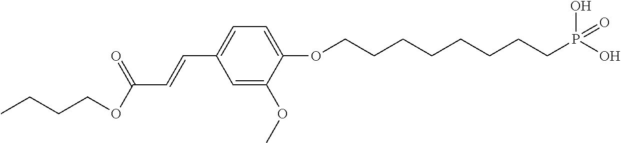 [SMILES: CCCCOC(=O)/C=C/c1ccc(OCCCCCCCCP(=O)(O)O)c(OC)c1] | 0-2 | 99.4 | 5.0 |
| Compound 13 | 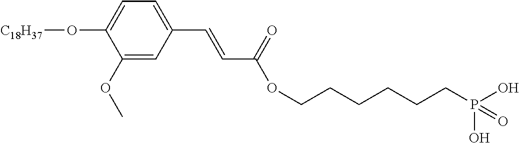 | 86 | 98.3 | 6.5 |

### Example 20—Azimuthal Anchoring Energy (AAE) Measurement

The LC cell was set as a twist nematic cell for measuring AAE. The AAE was obtained by measuring the twist angle of the cell, referring to [Ichimura Y., Kobayashi N. K. N., Kobayashi S. K. S. A new method for measuring the azimuthal anchoring energy of a nematic liquid crystal. Japanese journal of applied physics, 1994, 33 (3B): L434.]. The value reached 1.14×10⁻⁴ J/m².

### Example 21—Alignment Stability

In order to check the stability of alignment provided with new compounds, the transmittance versus voltage curve (TVC) of LC cells are measured before and after shining with light: (i) stability to visible light: the cell is put at 3 cm under a 450 lm lamp (67.4 mW/cm² at 555 nm) for 24 h, approximately 5.8 KJ/cm² (ii) UV stability: the cell is exposed with 365 nm UV light for dosage of 2 J/cm². The resulted TVC's are given in FIG. 6, where within experimental errors any evolution of the curves before or after irradiation were not detected.

What is claimed is:

1. A photoalignment layer comprising at least one precursor compound selected from the group consisting of a compound of Formula I, II, III, IV, and V: 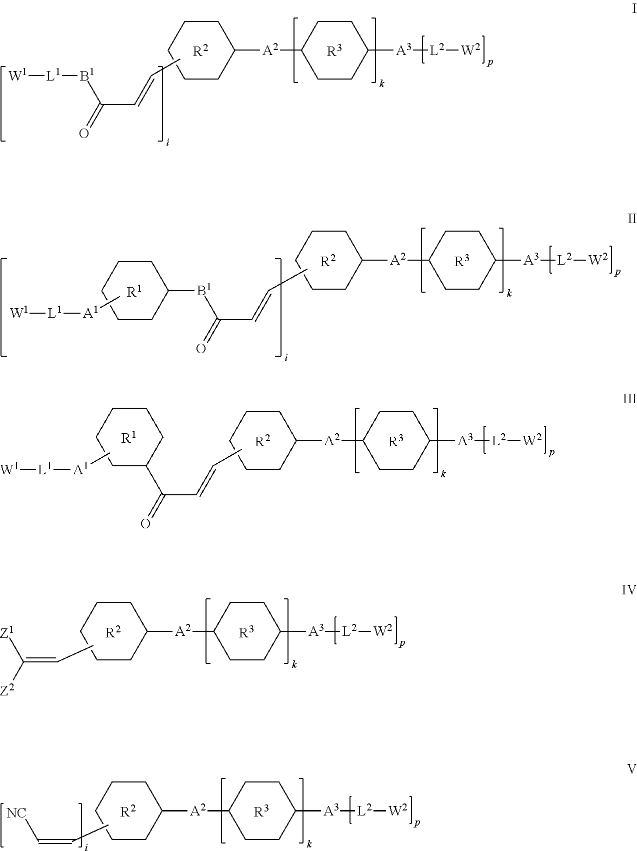
wherein:
i is 1 or 2;
k is 0 or 1;
p is 1 or 2;
R¹ is benzene-1,3-diyl or benzene-1,4-diyl, wherein R¹ is optionally substituted with one or more moieties selected from the group consisting of fluorine, chlorine, cyano, —C₁-C₁₀ alkyl, or —O—C₁-C₁₀ alkyl;
each of R² and R³ is independently selected from the group consisting of benzene-1,3-diyl, benzene-1,4-diyl, benzene-1,3,5-triyl, pyrimidine-2,5-diyl, pyridine-2,5-diyl, 2,5-thiophenylene, 2,5-furanylene, 1,4- or 2,6-naphthyle, wherein each of R² and R³ is independently optionally substituted with one or more moieties selected from the group consisting of fluorine, chlorine, cyano, —C₁-C₁₀ alkyl, or —O—C₁-C₁₀ alkyl;
W¹ is hydrogen and W² is PO(OH)₂ or W¹ is PO(OH)₂ and W² is hydrogen;
each of L¹ and L² is independently —(CH₂)₁₋₂₀-optionally substituted with one or more F; furthermore; and one or more —CH₂— is optionally independently replaced with —CF₂—, —O—, or —(C═O)— moieties provided that two O atoms are not linked together;
each of A¹, A², and A³ is independently a covalent bond, —O—, —S—, —(C═O)O—, or —O(C═O)—;
each of Z¹ and Z² is independently selected from the group consisting of a carboxylic acid, a carboxylic ester, cyano, a phosphine oxide P═O, a sulfoxide S═O, a sulfonic SO₂, a carbonyl, a pyridine, a pyrimidine, a quinoline, and a quinazoline; and
B¹ is a covalent bond, —O—, —NH—, —N(C₁-C₁₂ alkyl)-, —OCH₂—, —CH₂O—, —(C═O)O— or —O(C═O)—.

2. The photoalignment layer of claim 1, wherein the at least one precursor compound is conjugated to a surface of a substrate.

3. The photoalignment layer of claim 2, wherein the substrate comprises a metal oxide.

4. The photoalignment layer of claim 2, wherein the substrate is selected from the group consisting of indium tin oxide (ITO), aluminum-doped zinc oxide (AZO), indium-doped cadmium oxide (ICO), indium zinc oxide (IZO), alumina, silica, and combinations thereof.

5. The photoalignment layer of claim 1, wherein each of i and p is 1.

6. The photoalignment layer of claim 1, wherein R¹ is benzene-1,4-diyl optionally substituted with one or more moieties selected from the group consisting of fluorine, chlorine, cyano, —C₁-C₁₀ alkyl, or —O—C₁-C₁₀ alkyl.

7. The photoalignment layer of claim 1, wherein each of R² and R³ is independently selected from the group consisting of benzene-1,4-diyl optionally substituted with one or more moieties selected from the group consisting of fluorine, chlorine, cyano, —C₁-C₁₀ alkyl, or —O—C₁-C₁₀ alkyl.

8. The photoalignment layer of claim 1, wherein the at least one precursor compound is selected from the group consisting of: 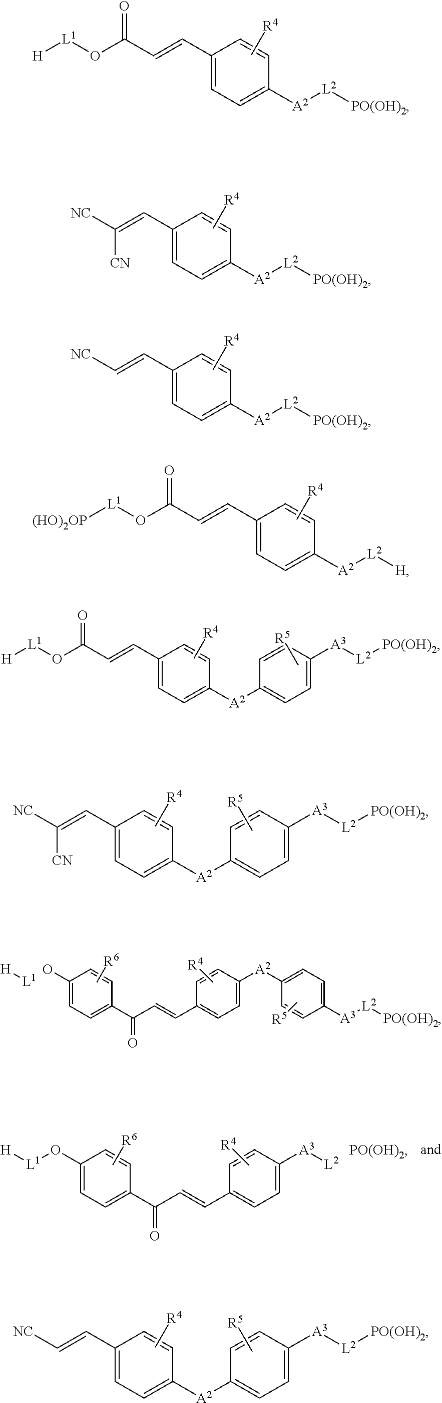
wherein:
each of A² and A³ is independently a covalent bond, —O—, —S—, —(C═O)O—, or —O(C═O)—;
each of L¹ and L² is independently —(CH₂)₁₋₂₀-optionally substituted with one or more F; furthermore; and one or more —CH₂— is optionally independently replaced with —CF₂—, —O—, or —(C═O)— moieties provided that two O atoms are not linked together; and
each of R⁴, R⁵, and R⁶ is independently hydrogen, fluorine, chlorine, cyano, —C₁-C₁₀ alkyl, or —O—C₁-C₁₀ alkyl.

9. The photoalignment layer of claim 8, wherein each of A² and A³ is independently —O— or —O(C═O)—; each of L¹ and L² is independently —(CH₂)₆₋₁₄—; and each of R⁴, R⁵, and R⁶ is independently hydrogen or —OMe.

10. The photoalignment layer of claim 1, wherein the at least one precursor compound is selected from the group consisting of: 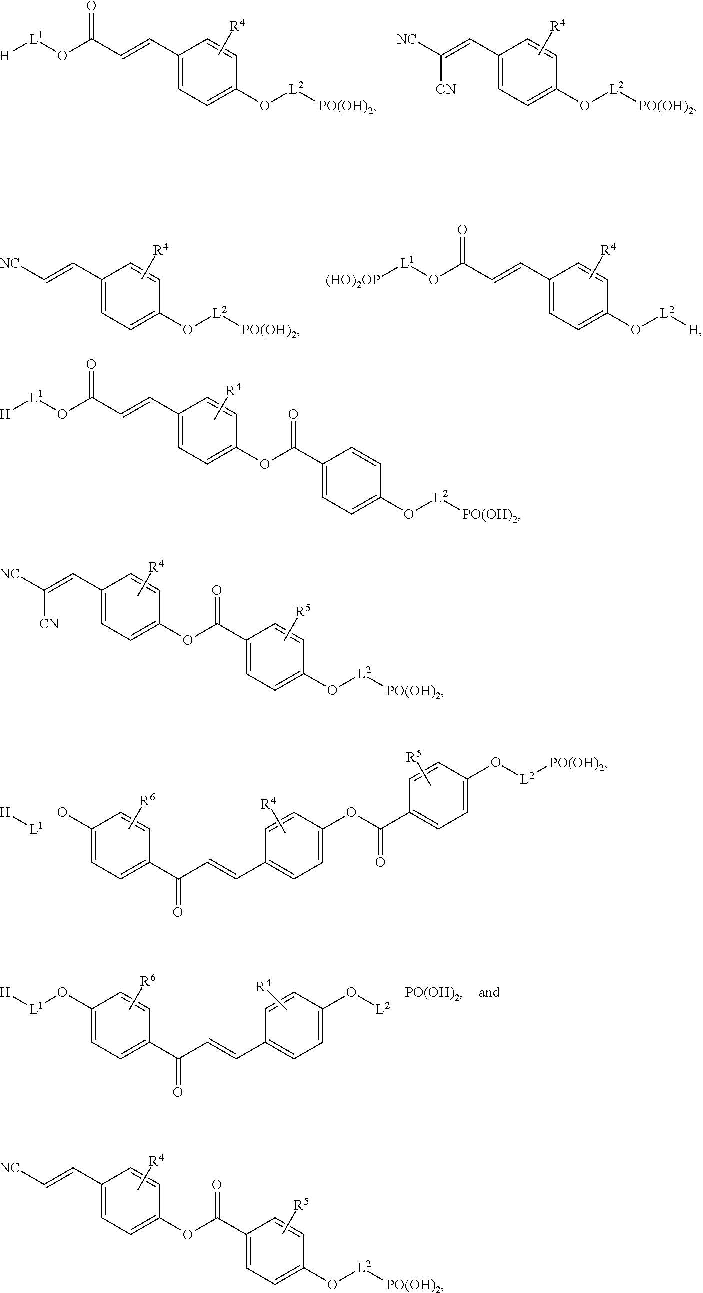
wherein:
each of L¹ and L² is independently —(CH₂)₁₋₂₀-optionally substituted with one or more F; furthermore; and one or more —CH₂— is optionally independently replaced with —CF₂—, —O—, or —(C═O)— moieties provided that two O atoms are not linked together; and
each of R⁴, R⁵, and R⁶ is independently hydrogen, fluorine, chlorine, cyano, —C₁-C₁₀ alkyl, or —O—C₁-C₁₀ alkyl.

11. The photoalignment layer of claim 10, wherein each of R⁴ and R⁵ is —OMe.

12. The photoalignment layer of claim 1, wherein the at least one precursor compound is selected from the group consisting of:

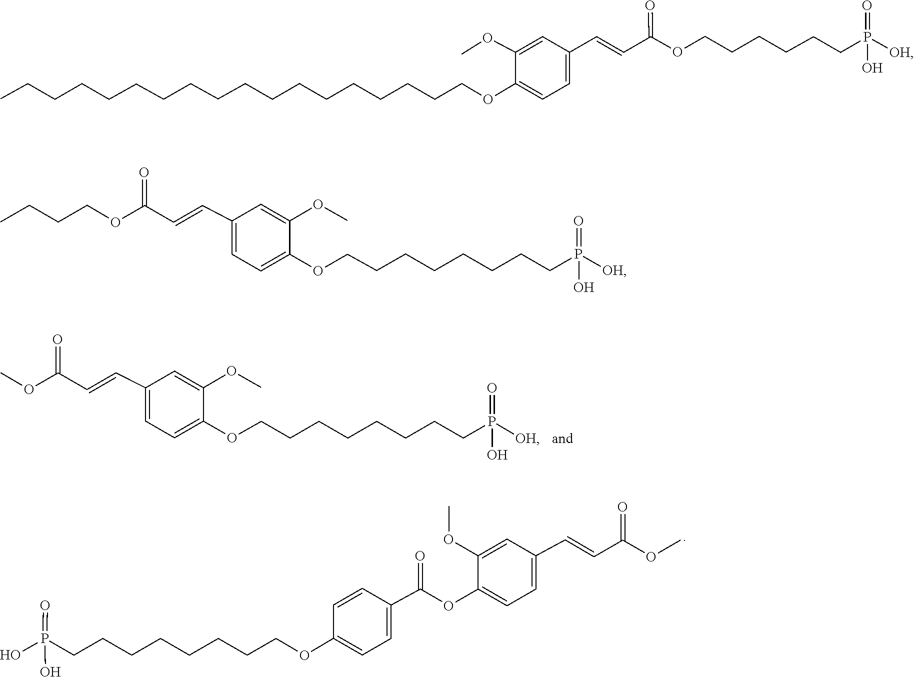 [SMILES: CCCCCCCCCCCCCCCCCCOc1ccc(/C=C/C(=O)OCCCCCCP(=O)(O)O)cc1OC ; CCCCOC(=O)/C=C/c1ccc(OCCCCCCCCP(=O)(O)O)c(OC)c1 ; COC(=O)/C=C/c1ccc(OCCCCCCCCP(=O)(O)O)c(OC)c1 ; COC(=O)/C=C/c1ccc(OC(=O)c2ccc(OCCCCCCCCP(=O)(O)O)cc2)c(OC)c1]

13. The photoalignment layer of claim 13, wherein the at least one precursor compound is conjugated to a surface of a substrate, wherein the substrate is indium tin oxide (ITO) or alumina.

14. The photoalignment layer of claim 1, wherein the at least one precursor compound is two precursor compounds selected from the group consisting of a compound of Formula I, II, III, IV, and V.

15. A method of preparing a photoalignment layer comprising a dimerized or polymerized compound, the method comprising: providing a substrate with the photoalignment layer of claim 1 coated on a surface of the substrate and exposing the photoalignment layer to a polarized electromagnetic radiation thereby inducing dimerizing or polymerizing the at least one precursor compound and forming the photoalignment layer comprising the dimerized or polymerized compound.

16. The method of claim 15, wherein the polarized electromagnetic radiation has a wavelength of 280-400 nm.

17. The method of claim 15 further comprising depositing a composition comprising a liquid crystal on a surface of the photoalignment layer before the step of exposing the photoalignment layer to a polarized electromagnetic radiation or after the step of exposing the photoalignment layer to a polarized electromagnetic radiation.

18. A photoalignment layer comprising the dimerized or polymerized compound prepared according to the method of claim 15.

19. The photoalignment layer comprising the dimerized or polymerized compound of claim 18, wherein the photoalignment layer has a pretilt angle of 0-10 degrees or 80-90 degrees.

20. A liquid crystal device comprising the photoalignment layer comprising the dimerized or polymerized compound of claim 18 and a liquid crystal layer.
